(19) United States
(12) Patent Application Publication
(10) Pub. No.: US 2017/0284699 A1
(43) Pub. Date: Oct. 5, 2017

(54) AIR CONDITIONER / HEATER ATTACHMENT SYSTEMS

(71) Applicant: Ioffe Ezequiel, Aventura, FL (US)

(72) Inventor: Ioffe Ezequiel, Aventura, FL (US)

(21) Appl. No.: 15/083,320

(22) Filed: Mar. 29, 2016

(51) Int. Cl. F24F 13/28; F16M 13/02; F16B 47/00

(52) U.S. Cl. CPC F24F 13/28; F16B 47/003; F16M 13/02; F16B 2001/0035

(57) ABSTRACT

An AC/Heater attachment systems has various types of devices to attach a filter system to a ducting port. A magnetic U shaped device has a raised lip for placement of a filter therein; the device is made from naturally magnetic material or is coated with a magnetic paint. Diamond clip type attachment devices are attachable to a filter in slots precut into a filter. Further, a slidable second associated device cooperates with the first to effect a variable one dimensional size. A 3D logo can be affixed along a surface of one of the devices taught herein. A double sided tape can be attached along a surface of the filter attachment device in lieu of a magnetic attachment mechanism. A collapsible and adjustable devices are also envisioned with protrusion and hinge actuation devices.

### FIELD OF THE INVENTION

The present invention relates to an air conditioner system attachment system. More particularly, the present invention relates to novel devices and systems of attaching a filter to an air conditioner and or heater ducting system.

### BACKGROUND OF THE INVENTION

Air conditioner (AC) and Heating systems are deployed in a variety of residential and business complexes. These change the properties of the environment (primarily the temperature and humidity) to more comfortable conditions typically with the aim of distributing the air to an occupied space such as a building or residential space. In addition to the AC and Heating system, users have inserted filter devices into the ducts utilized to spread the air. Typically an open space in the duct has a housing for placement of a filter therein; once inserted therein a door or covering grill is closed thereby enclosing the filter in the housing. It is well known that there are various types of these filtering system employed throughout the world.

FIG. 1 presents a prior art wall ducting system having a space for insertion of a filter device therein. A wall ducting system 1 is shown having an air filter housing formed from recessed sets of surfaces 2a-2d, 3a-3d located in the wall that they are formed on. The first set of surfaces 2a-2d are roughly perpendicular to the wall they are formed on moving inwards towards the wall and away from the surrounding room space. They form a first right surface 2a, a first bottom surface 2b, a first left surface 2c and a first top surface 2d.

Similarly, the second set of surfaces 3a-3d form a peripheral ledge for an airway 4 and for abutting an inserted filter device; also, these are approximately parallel to the wall they are incorporated in and approximately perpendicular to the corresponding first set of surfaces 2a-2d. Thus, they form a second right surface 3a that is integral with the first right surface 2a along an edge thereof; a second bottom surface 3b that is integral with the first bottom surface 2b along an edge thereof; a second left surface 3c that is integral with the first left surface 2c along an edge thereof; and a second top surface 3d that is integral with the first top surface 2d along an edge thereof. These 3a-3d are further integral with each other sequentially along shorter transverse edges forming a ledge back space. A user would typically insert the filter device until it reaches the ledge back space formed by surfaces 3a-3d and then cover it with a grill, faceplate or similar device.

The use of these filters has one drawback in that they generally require a grill or cover and during installation they tend to fall out of the ducting or AC or Heater unit. Additionally, there is time wasted in installing the prior art as it takes time to remove the grill or faceplate cover.

Accordingly, there needs to be some solution to overcome the aforementioned problems.

### SUMMARY OF THE INVENTION

The present invention overcomes the deficiencies of the known art and the problems that remain unsolved by providing

An attachment device comprising:
a first leg attached along a first edge thereof to
a first intermediate leg second edge and
a third edge of the first intermediate leg attached to
a second leg wherein the first leg and second leg are parallel to each other.
In another aspect, further comprising:
   a first raised lip along the first leg.
In another aspect, further comprising:
   a second raised lip along the second leg.
In another aspect, further comprising:
   a second raised lip along the first leg.
In another aspect, further comprising:
   a second raised lip along the second leg.
In another aspect, further comprising:
   a clip device attached to the intermediate leg such that the clip device extends inwards between the first and second leg.
In another aspect, further comprising:
   a second portion slidable device comprising
      a third leg parallel to
      a fourth leg integrally attached together through
         a second intermediate leg.
In another aspect, further comprising:
   wherein the attachment device is made from magnetic material.
In another aspect, further comprising:
   wherein the attachment device is coated with magnetic paint.
In another aspect, further comprising:
   wherein the attachment device has a double sided adhesive tape attached to a surface thereof.
In another aspect, further comprising:
   wherein the attachment device has a 3D logo attached thereto.
In another aspect, further comprising:
   a collapsible device system.
In another aspect, further comprising:
   a raised protrusion on depression pair.

An attachment system comprising:
a first unit having
   a first portion and
   a second portion connected together by
a first hinge device having a first raised lip along an edge of the first portion.
In another aspect, wherein the attachment system further comprises:
   a perforation in the first portion.
In another aspect, wherein the attachment system further comprises:
   a slot in the first portion.
In another aspect, wherein the attachment system further comprises:
   a perforation in the first second portion.
In another aspect, wherein the attachment system further comprises:
   a slot in the second portion.
In another aspect,
   a second unit having
      a third portion and
      a fourth portion connected together by
   a second hinge device having a third raised lip along an edge of the first portion.
In another aspect,
   a second raised lip along a second edge portion.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a prior art wall ducting system having a space for insertion of a filter device therein.

FIG. 2A presents a front view of a magnetic attachment device for insertion of a filter device in an embodiment herein.

FIG. 2B presents a front view of a filter device for insertion in any of the various attachment devices taught in embodiments herein.

FIG. 2C presents a closeup of an end portion of the magnetic attachment device taught in FIG. 2A in an embodiment herein.

FIG. 3A presents a front view of snap attachment device for insertion of a filter device in an embodiment herein.

FIG. 3B presents a side view of a filter device for insertion of the snap attachment device taught in FIG. 3A in an embodiment herein.

FIG. 3C presents a closeup of the snap attachment device of FIG. 3A in an embodiment herein.

FIG. 4A presents a front view of a first portion of an expandable attachment device for insertion of a filter device in an embodiment herein.

FIG. 4B presents a front view of a a second portion of an expandable attachment device for insertion of a filter device in an embodiment herein.

FIG. 5A presents an attachment device having a 3D logo affixed thereto in an embodiment taught herein.

FIG. 5B presents a 3D image or logo used in the embodiment of FIG. 5A in an embodiment taught herein.

FIG. 6 presents a front view of a double sided tape actuated attachment device for insertion of a filter device therein in an embodiment taught herein.

FIG. 7A presents a front view of a first portion of a collapsible attachment device for easy portage having the ability to hold a filter device in an embodiment taught herein.

FIG. 7B presents a front view of a second portion of a collapsible attachment device for easy portage having the ability to hold a filter device in an embodiment taught herein.

FIG. 7C presents a closeup of an engagement site for the first and second portion of the collapsible attachment device of FIGS. 7A and 7B in an embodiment taught herein.

FIG. 8A presents a front view of two portions of a size adjustable attachment device for insertion of a filter device therein such that it is fully extended in an embodiment taught herein.

FIG. 8B presents a front view of two portions of a size adjustable attachment device for insertion of a filter device therein such that it is reduced in size in an embodiment taught herein.

FIG. 8C presents a clip used in the embodiment of FIG. 8A-8B.

FIG. 8D presents a spring activated mechanical clip utilized to grip the two portions in the embodiments of FIG. 8A-8B.

FIG. 8E presents a closeup view of the a gripping portion of the hinges in the embodiment of FIG. 8A-8B.

FIG. 8F presents a closeup view of the axial portion of the hinges in the embodiment of FIG. 8A-8B.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

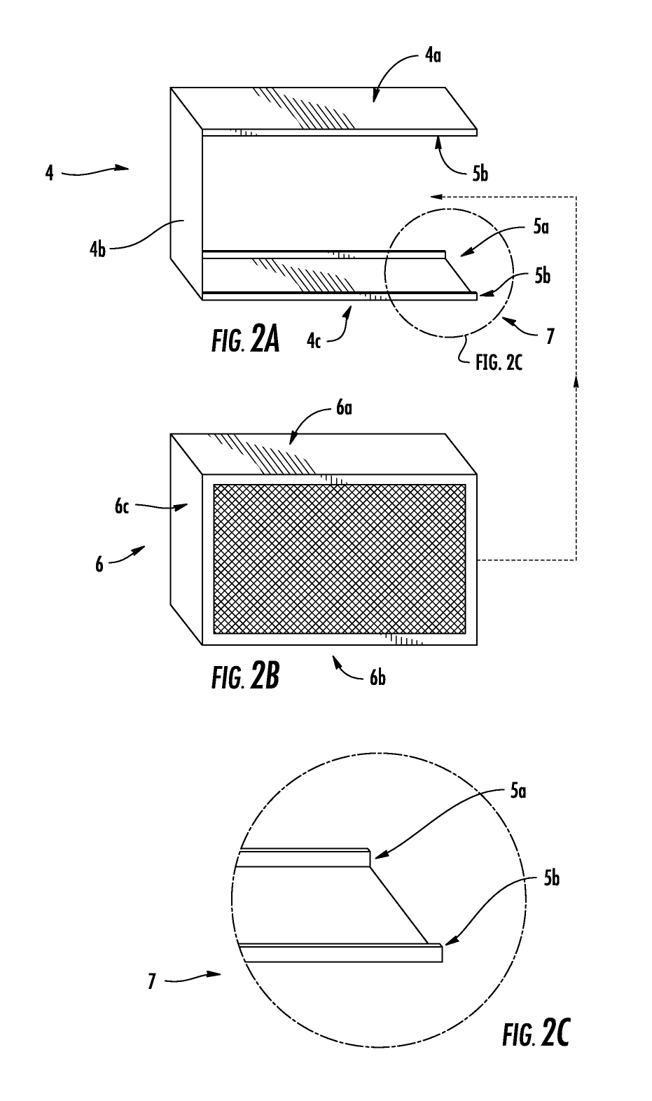

FIG. 2A presents a front view of a magnetic attachment device for insertion of a filter device in an embodiment herein. The magnetic attachment device 4 is a U shaped device having three legs, namely, 4A, 4B, 4C. Legs 4A and 4C are parallel to each other and are integrally attached along a respective edge to a centrally disposed intermediate leg 4B along two respective end edges thereof. The two legs 4A, 4C each have two integral raised upwardly directed lips 5a, 5b along the outer longitudinal edges thereof. These are also directed towards the opposite leg.

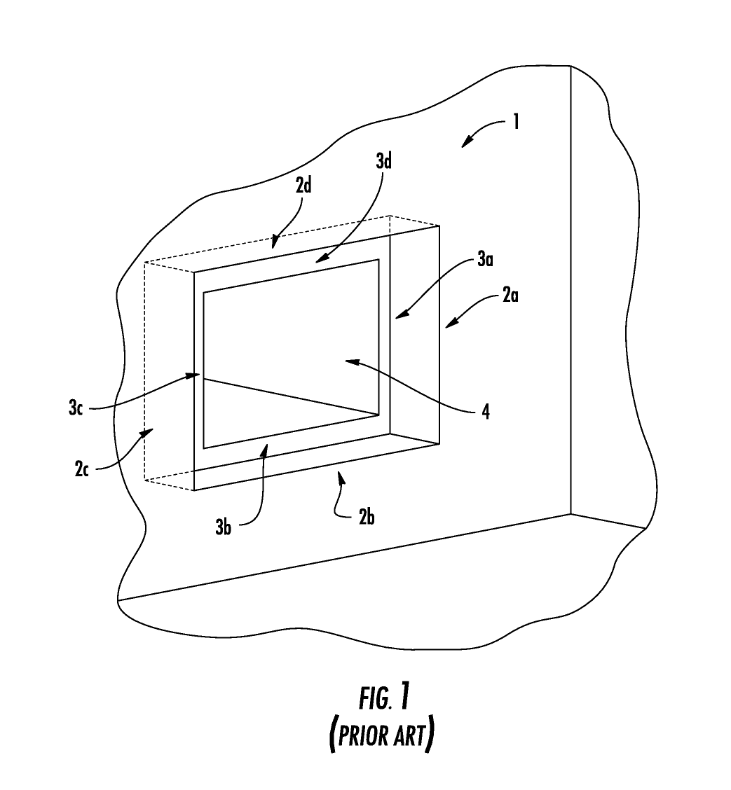

Thus, the lips 5a, 5b on 4A are directed towards 4C and the lips 5a, 5b on 4C are directed towards 4A. Because of this, the two lips 5a, 5b on both 4A, 4C are intended to hold a filter device that is designed to slide therein. Once the filter device is inserted within the confines of the upper and lower sets of raised lips 5a, 5b a user inserts the U shaped attachment device into the recessed area of FIG. 1 for example where it engages by magnetic connection. It should be understood that the materials in the recessed area of FIG. 1 are either iron based or magnetically affected materials or are coated with magnetic paint. Similarly, the U shaped attachment device itself is either made from magnetic materials or is a plastic, wood, polymer or similar material that has been coated with magnetic paint. Any of the embodiments herein taught are realizable with the same type of materials.

FIG. 2B presents a front view of a filter device for insertion in any of the various attachment devices taught in embodiments herein. This filter device 6 has four lateral walls top 6A, bottom 6B, left side 6C, and right side 6D as well as filter materials incased therein. This filter device is slid between the raised lips of 5a-5b of FIG. 2A.

FIG. 2C presents a closeup view of an end portion 7 of the magnetic attachment device taught in FIG. 2A in an embodiment herein. This closeup shows the raised lips 5a-5b of either parallel leg 4A, 4C of FIG. 2A.

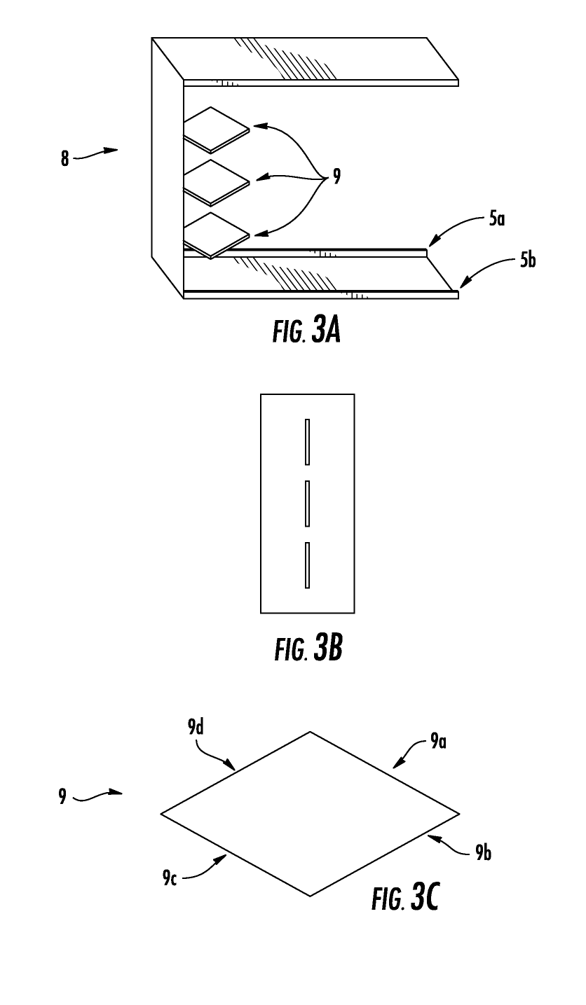

FIG. 3A presents a front view of a snap attachment device for insertion of a filter device in an embodiment herein. The U shaped snap attachment device 8 has several diamond shaped snap devices 9 attached thereto along an intermediate leg 4B. The diamond shaped snap devices are typically a hard plastic or metallic material that are either adhesively attached to and or welded to the material of the intermediate leg 4B along a vertex of the respective diamond. These diamond shaped snap devices 9 are arranged parallel to the extended top and bottom legs 4A and 4B as in FIG. 2A. Legs 4A and 4C are parallel to each other and are each integrally attached along a respective edge to a centrally disposed intermediate leg 4B along two respective end edges thereof. The two legs 4A, 4C each have two raised upwardly directed lips 5a, 5b along the outer longitudinal edges thereof. These are also directed towards the opposite leg.

FIG. 3B presents a side view of a filter device for insertion of the snap attachment device taught in FIG. 3A in an embodiment herein. A filter device has several slots 9e for insertion of the diamond shaped snap devices 9 therein when the filter device 8a is inserted between the raised lips 5a-5b of the upper and lower arms 4A, 4C.

FIG. 3C presents a closeup of the snap attachment device of FIG. 3A in an embodiment herein. The snap attachment device 9 has several arms 9a, 9b, 9c, 9d forming a diamond. Thus, a right top arm 9a attaches at an end thereof to a first end of a right lower arm 9b whose other end is attached to a left lower arm 9c that has its other end attached to a first end of an upper left arm 9d that has its other end attached to the other end of the upper right arm 9a completing the circuit.

FIG. 4A presents a front view of a first portion of an expandable attachment device for insertion of a filter device in an embodiment herein. The magnetic attachment device 4 is a U shaped device having three legs, namely, 4A, 4B, 4C. Legs 4A and 4C are parallel to each other and are integrally attached along a respective edge to a centrally disposed intermediate leg 4B along two respective end edges thereof. The two legs 4A, 4C each have two integral raised upwardly directed lips 5a, 5b along the outer longitudinal edges thereof. These are also directed towards the opposite leg.

FIG. 4B presents a front view of a second portion of an expandable attachment device for insertion of a filter device in an embodiment herein. The second portion 10 of the expandable attachment device is somewhat smaller than the first portion 4 and is similarly a U shaped device. The magnetic attachment device 10 is a U shaped device having three legs, namely, 10A, 10B, 10C. Legs 10A and 10C are parallel to each other and are integrally attached along a respective edge to a centrally disposed intermediate leg 10B along two respective end edges thereof. This second portion is intended to be slid within along the inside edges of the raised lips 5a, 5b with the filter device already deployed within the confines of 5a, 5b. Thus, a user can vary the size of the attachment device by sliding it inwards and outwards for various size filters and ducting systems.

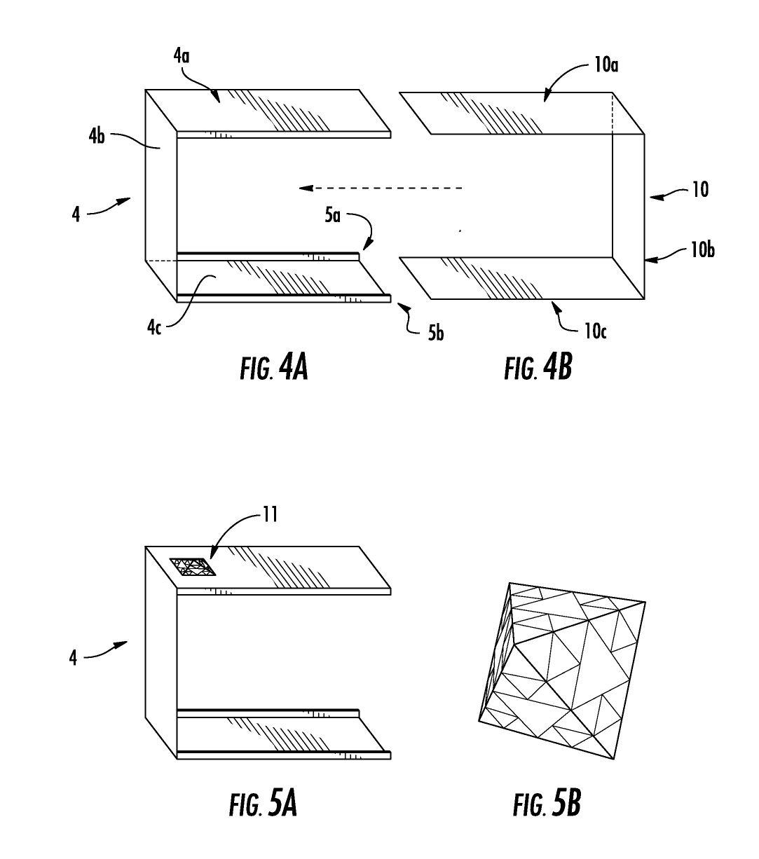

FIG. 5A presents front view of an attachment device having a 3D logo 11 affixed thereto in an embodiment taught herein. This logo is designed in a 3D printer and affixed (using adhesives, silicone seal, glue et cetera) along an upper, lower, inner, outer edge (etc) of the legs 4a, 4b, 4c for example, alternatively 10a, 10b, 10c or along a convenient surface of any of the devices herein taught in any embodiment.

FIG. 5B presents a 3D image 11 or logo used in the embodiment of FIG. 5A in an embodiment taught herein.

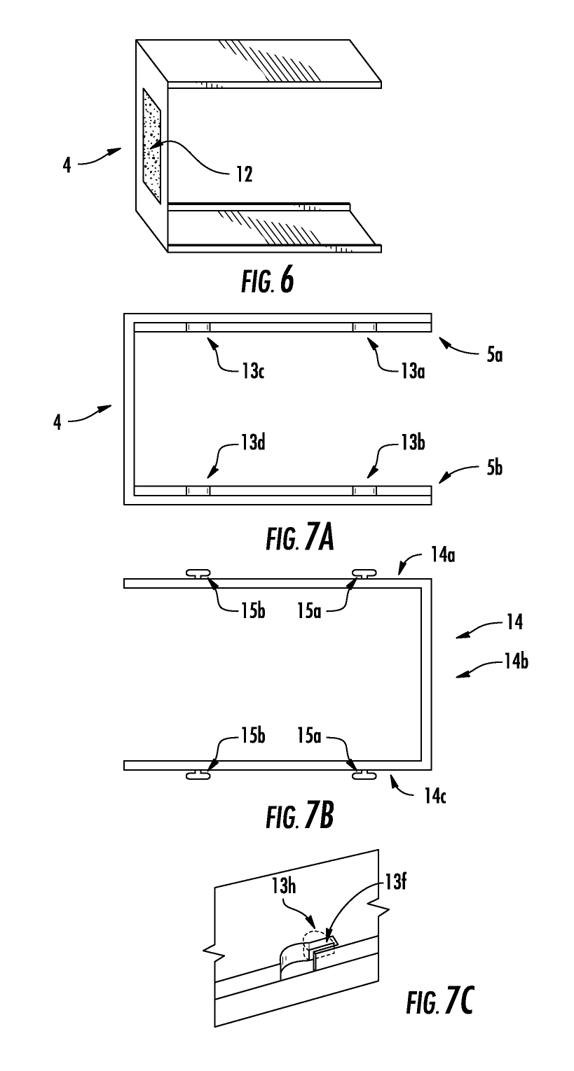

FIG. 6 presents a front view of a double sided tape actuated attachment device for insertion of a filter device therein in an embodiment taught herein. In this embodiment, instead of the materials of arms 4A, 4B, 4C being made from magnetic material or coated with magnetic paint, a double sided adhesive 12 is applied to an outside surface of the attachment device thereby permitting it to be attached to a surface of the recessed portion of FIG. 1; for example, to the side 2C thereof. Any of the other embodiments for example, FIG. 2A-2C, FIG. 3A-3C, 4A-4B, 5A-5B, 7A-C, 8A-F can alternatively use this double sided material for attachment in lieu of the magnetic materials previously taught.

FIG. 7A presents a front view of a first portion of a collapsible attachment device for easy portage having the ability to hold a filter device in an embodiment taught herein. A U shaped collapsible attachment device first portion has been modified from that shown in FIG. 2A, 4A as follows. Two top slots 13a, 13c are located along one of the raised lips 5a, 5b along the top leg 4A and two bottom slots 13b, 13d are located along one of the raised lips 5a, 5b along the bottom leg 4C. Of, course to function the slots must be on the top and bottom lips 5a or the top and bottom 5b lips so that collapsing function can be properly paired between slot and raised protrusion as shown in FIG. 7B.

FIG. 7B presents a front view of a second portion of a collapsible attachment device for easy portage having the ability to hold a filter device in an embodiment taught herein; this second portion is arranged in a U shaped device having three legs 14a, 14b and 14c. The first leg 14a is parallel to 14c and integrated with 14b along an edge thereof; similarly leg 14c is integrated with an edge of leg 14b along an opposite edge of that integrated with leg 14a. Thus, a U shaped second portion 14 of a collapsible attachment device is modified from that shown in FIG. 4B. In this figure, 7B two sets of inwardly directed raised protrusions 15a, 15b are presented along the outer portions of legs 14a (top thereof), 14c (bottom thereof) of the U shaped device; it should be understood that these raised protrusions are directed towards those on an opposite leg. In this fashion, those raised protrusions 15a, 15b on leg 14a are directed towards those on leg 4a and those of 14c are directed to those on 4c. It is clear from the figure that the raised protrusions are cleats or mushroom head types that are designed to engage by sliding into a slot along the neck of the protrusion and the head thereof thereby holding the device in place within an engagement site.

FIG. 7C presents a closeup of an engagement site for the first and second portion of the collapsible attachment device of FIGS. 7A and 7B in an embodiment taught herein. The engagement sites of first portion 4: 13a, 13b, 13c, 13d engage corresponding protrusions on the second portion 14. For example, an engagement site 13b is shown such that a raised protrusion is inserted large head down into a slot 13g of the engagement site 13b that has a curved back 13e along the raised lip. The slot narrows dramatically as it travels down the raised lip 5a, 5b to a small overhang or depression slot 13f so that the head of the raised protrusion can not disengage therefrom. Even smaller raised protrusions on the surfaces therein are optional to help ‘snap’ the part in place.

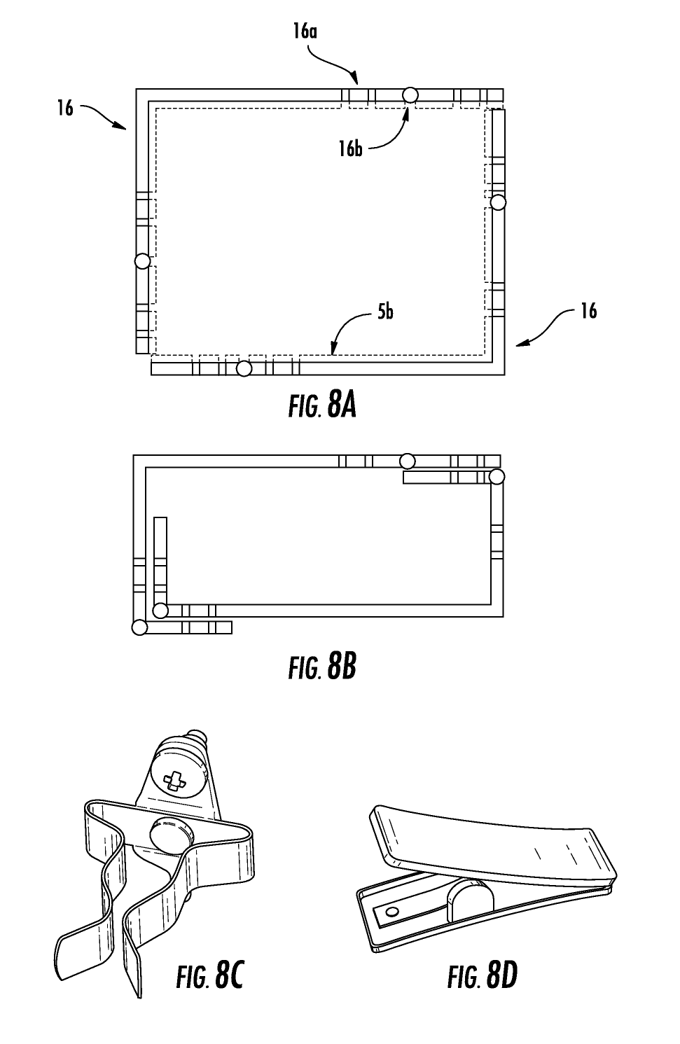

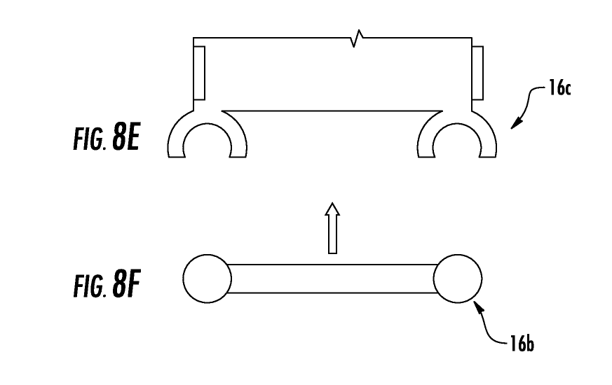

FIG. 8A presents a front view of two portions of a size adjustable attachment device for insertion of a filter device therein such that it is fully extended in an embodiment taught herein. Two corresponding L shaped foldable size adjustable attachment devices 16 (L shaped device for short) are shown in FIG. 8A. Each of these has at two portions and at least one or more hinge devices 16b connecting the portions and one or more perforations (and or slots along a side) 16a in the L shaped devices on either side of the hinge device 16b. By folding the L shaped device along one or more of the hinge devices it is orientable into different sizes. By arranging the perforations (and or slots along a side) 16a together, a clip can be inserted therein between these 16a so that the first and second adjustable attachment devices 16 are connected together. Of course, a filter is insertable therein within raised lips that have been shown as dotted lines for simplicity; they are broken where perforations (and or slots along a side) penetrate the material of 16a, 16b for connection using clips shown below.

FIG. 8B presents a front view of two portions of a size adjustable attachment device for insertion of a filter device therein such that it is reduced in size in an embodiment taught herein. By folding the L shaped device along one or more of the hinge devices it is orientable into different sizes. By arranging the slots 16a together, a clip can be inserted therein for connecting the two together.

FIG. 8C presents a clip used in the embodiment of FIG. 8A-8B.

FIG. 8D presents a spring activated mechanical clip utilized to grip the two portions in the embodiments of FIG. 8A-8B.

FIG. 8E presents a closeup view of the a gripping hinge arms in the embodiment of FIG. 8A-8B. These hinge arms are curved lobster clasp type devices that are designed to be closed about a portion of an axle as taught below.

FIG. 8F presents a closeup view of the axial portion of the hinges in the embodiment of FIG. 8A-8B. A central axle having larger round edges serve as a mounting point for the hinge arms of FIG. 8E. These hinge arms engage the axle and are bent there around for locking the two together. Another portion of the adjustable attachment device engages the axle similarly but along a different portion thereof; thus, the hinge arms are offset slightly from the other adjustable attachment device.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

1. A filter holder comprising:
a first slide having:
a first leg integrally attached along a first edge thereof to
a first intermediate leg second edge and
a third edge of the first intermediate leg integrally attached to
a second leg wherein the first leg and second leg are parallel to each other.

2. The filter holder of claim 1, further comprising:
a first raised lip along the first leg.

3. The filter holder of claim 2, further comprising:
a second raised lip along the second leg.

4. The filter holder of claim 2, further comprising:
a second raised lip along the first leg.

5. The filter holder of claim 3, further comprising:
a third raised lip along the second leg.

6. The attachment device of claim 1, further comprising:
a clip device attached to the intermediate leg such that the clip device extends inwards between the first and second leg.

7. The filter holder of claim 1, further comprising:
a second slide comprising
a third leg parallel to
a fourth leg integrally attached together through
a second intermediate leg wherein the third leg is moveably situated along the first leg and the fourth leg is moveably situated along the fourth leg such that the first slide and the second slide are moveable with respect to one another.

8. The filter holder of claim 1, further comprising:
wherein the first slide is made from magnetic material.

9. The filter holder of claim 1, further comprising:
wherein the first slide is coated with magnetic paint.

10. The attachment device of claim 1, further comprising:
wherein the attachment device has a double sided adhesive tape attached to a surface thereof.

11. The attachment device of claim 1, further comprising:
wherein the attachment device has a 3D logo attached thereto.

12. The attachment device of claim 1, further comprising:
a collapsible device system.

13. The attachment device of claim 12, wherein the collapsible device system further comprises:
a raised protrusion on depression pair.

14. An attachment system comprising:
a first unit having
a first portion and
a second portion connected together by
a first hinge device having a first raised lip along an edge of the first portion.

15. The attachment system of claim 14, wherein the attachment system further comprises:
a perforation in the first portion.

16. The attachment system of claim 14, wherein the attachment system further comprises:
a slot in the first portion.

17. The attachment system of claim 14, wherein the attachment system further comprises:
a perforation in the first second portion.

18. The attachment system of claim 14, wherein the attachment system further comprises:
a slot in the second portion.

19. The attachment system of claim 14, further comprises:
a second unit having
a third portion and
a fourth portion connected together by
a second hinge device having a third raised lip along an edge of the first portion.

20. The attachment system of claim 14, further comprising:
a second raised lip along a second edge portion.

21. An adjustable-size filter holder comprising:
a first slide having:
a first leg integrally attached along a first edge thereof to
a first intermediate leg second edge and
a third edge of the first intermediate leg integrally attached to
a second leg wherein the first leg and second leg are parallel to each other wherein the first slide is moveably associated with a second similar slide thereby effecting the adjustable size filter holder.
